(19) United States
(12) Patent Application Publication
(10) Pub. No.: US 2009/0155456 A1
(43) Pub. Date: Jun. 18, 2009

(54) System and Method for Fingerprint-Resistant Surfaces for Devices Using Fingerprint Sensors

(75) Inventors: Fred George Benkley, Andover, MA (US); David Joseph Geoffroy, Amherst, MA (US)

Correspondence Address: Stevens Law Group, 1754 Technology Drive, Suite #226, San Jose, CA, 95110, US

(73) Assignee: Validity Sensors, Inc., San Jose, CA (US)

(21) Appl. No.: 11/957,162

(22) Filed: Dec. 14, 2007

(51) Int. Cl. B05D 5/06; G05B 19/00

(52) U.S. Cl. 427/64; 340/5.83

(57) ABSTRACT

The invention is an enhanced security fingerprint scanner method and system designed to minimize the risk of fingerprint “spoofing” by minimizing the probability that latent fingerprints from authorized users will be inadvertently left on the device. In a preferred embodiment, surfaces of the device where the probably of authorized users inadvertently leaving latent fingerprints is particularly high are covered with fingerprint resistant or camouflaging material.

### BACKGROUND

Security in electronic devices has become a major concern of manufacturers and users of such devices. This is particularly true for devices such as computers, personal hand held devices, cellular phones, smart cards, and other devices that contain sensitive information. Developers of electronic devices continuously strive to develop systems and methods that make their products impervious to unauthorized access or use. Often manufacturers do this by incorporating additional security devices in their products.

These security devices include everything from simple passwords, to encryption devices and dongles, to biometric sensors such as fingerprint sensors. Fingerprint sensors are particularly popular in this regard, because each user has a unique set of fingerprints, and fingerprints do not require the user to remember complex passwords. Because fingerprint sensors are so popular, however, methods of fooling or “spoofing” fingerprint sensors have also become well known. Thus methods to help prevent fingerprint sensors from being “spoofed” are commercially important.

Various types of fingerprint readers exist. Some read the whole fingerprint at once, and some only read a portion of a fingerprint at a given time, and function by assembling partial fingerprint images into a complete image. Some work by optical means, some by pressure sensor means, and others by capacitance sensing means or radiofrequency sensing means.

For example, one common configuration used for a fingerprint sensor is a one or two dimensional array of CCD (charge coupled devices) or C-MOS circuit sensor elements (pixels). These components are embedded in a sensing surface to form a matrix of pressure sensing elements that generate signals in response to pressure applied to the surface by a finger. These sensors often only output a portion of a fingerprint at any given instant. To use these devices, the user swipes his finger over the partial fingerprint sensor, and the sensor creates a large number of partial fingerprints. These partial fingerprints are read by a processor and used to reconstruct the fingerprint of a user and to verify identification.

Other devices include one or two dimensional arrays of optical sensors that read light reflected off of a person's finger and onto an array of optical detectors. The reflected light is converted to a signal that defines the fingerprint of the finger analyzed and is used to reconstruct the fingerprint and to verify identification.

One class of partial fingerprint sensors that are particularly useful for small device applications are deep finger penetrating radio frequency (RF) based sensors. These are described in U.S. Pat. Nos. 7,099,496; 7,146,024; and patent application Ser. Nos. 11/107,682; 11/112,338; 11,243,100; 11/184,464, and the contents of these patents and patent applications are incorporated herein by reference. These types of sensors are commercially produced by Validity Sensors, Inc, San Jose Calif. This class of sensor mounts the sensing elements (usually arranged in a one dimensional array) on a thin, flexible, and environmentally robust support, and the IC used to drive the sensor in a protected location some distance away from the sensing zone. Such sensors are particularly advantageous in applications where small sensor size and sensor robustness are critical.

The Validity fingerprint sensors measure the intensity of electric fields conducted by finger ridges and valleys, such as deep finger penetrating radio frequency (RF) based sensing technology, and use this information to sense and create the fingerprint image. These devices create sensing elements by creating a linear array composed of many miniature excitation electrodes, spaced at a high density, such as a density of approximately 500 electrodes per inch. The tips of these electrodes are separated from a single sensing electrode by a small sensor gap.

The electrodes are electrically excited in a progressive scan pattern and the ridges and valleys of a finger pad alter the electrical properties (usually the capacitive properties) of the excitation electrode-sensing electrode interaction, and this in turn creates a detectable electrical signal. The electrodes and sensors are mounted on thin flexible printed circuit support, and these electrodes and sensors are usually excited and the sensor read by an integrated circuit chip (scanner chip, driver chip, scan IC) designed for this purpose. The end result is to create a one dimensional “image” of the portion of the finger pad immediately over the electrode array and sensor junction.

As the finger surface is moved across the sensor, portions of the fingerprint are sensed and captured by the device's one dimensional scanner, creating an array of one dimensional images indexed by order of data acquisition, and/or alternatively annotated with additional time and/or finger pad location information. Circuitry, such as a computer processor or microprocessor, then creates a full two-dimensional fingerprint image by creating a mosaic of these one dimensional partial fingerprint images.

Often the processor will then compare this recreated two dimensional full fingerprint, usually stored in working memory, with an authorized fingerprint stored in a fingerprint recognition memory, and determine if there is a match or not. Software to fingerprint matching is disclosed in U.S. Pat. Nos. 7,020,591 and 7,194,392 by Wei et. al., and is commercially available from sources such as Cogent systems, Inc., South Pasadena, Calif.

If the scanned fingerprint matches the record of an authorized user, the processor then usually unlocks a secure area or computer system and allows the user access. This enables various types of sensitive areas and information (financial data, security codes, etc.), to be protected from unauthorized users, yet still be easily accessible to authorized users.

Unfortunately, many security systems presently in use are vulnerable to various forms of attack. Automatic password creation programs and devices can attempt to either intercept passwords (e.g. through key loggers, packet sniffers, and the like). Security dongles or chips that contain encryption secrets that are stored in memory can be stolen, and the contents of the security memory deduced by either physical inspection of the chip's memory, or by electronic attack in which the chip is electronically interrogated with various stimuli, and a model that describes the chip's response to the various stimuli deduced.

Even finger print sensors can be spoofed by acquiring a copy of a legitimate user's fingerprint, and then using this fingerprint to create an “artificial” fingerprint to spoof a fingerprint sensor. Although such security breaking methods can sometimes be laborious, the value of the information that can be stored in modern equipment such as laptop computers and the like is often extremely high. This information can contain national security secrets, financial records of thousands or millions of individuals, new product engineering plans or marketing information, sensitive business transactions, sensitive medical information, and so on. Thus in many situations, the information is so valuable that the probability is relatively high that if unscrupulous individuals did in fact illegitimately gain access to a device containing sensitive information, these individuals would in fact avail themselves of sophisticated methods to gain access to this sensitive information.

Ironically, one of the most readily available sources of legitimate user fingerprints is the secure device itself. In normal use, a legitimate user will touch the secure device in many different locations, and thus will usually leave latent fingerprints all over the secure device. Unfortunately, due to the efforts of law enforcement over the last hundred years, technology to detect and analyze latent fingerprints is highly sophisticated, and this technology is easily available to the general public.

Latent fingerprints result when salts, urea, sugars, amino acids, and occasionally trace amounts of lipids, and other natural secretions, naturally present on finger tips due to skin pores (eccrine glands), are deposited on a surface. Although difficult to see with the naked eye (hence the term “latent”), these nearly invisible fingerprints can be enhanced and visualized by a variety of chemical and optical techniques.

In some situations, latent fingerprints may be observed by illuminating the fingerprint at angles and wavelengths of light that enhance the contrast between the fingerprint and its underlying surface. Since cell cameras are now ubiquitous, this type of fingerprint can be easily obtained by an attacker with almost no time or effort.

Failing pure optical methods, latent fingerprints may be developed by a variety of different chemical developer methods. Dusting the fingerprints with a fine powder (e.g. titanium dioxide, magnetic particles, graphite, etc.) is one option. Magnetic particles are used because the distribution of the particles can be easily manipulated with a magnetic wand. Other methods use chemical reactions, and include chemical agents such as ninhydrin spray, 1,8-diaza-9-flourenone (DFO), and cyanoacrylate (super glue) fuming, and other methods

Ninhydrin is a chemical agent that detects trace amounts of amino groups and produces an intense purple color which can then be photographed or chemically enhanced even further with various treatments such as physical developer. DFO is even more sensitive because it produces a fluorescent image. When illuminated at around 500 nm, and then viewed or photographed through a 550 nm bandpass filter, DFO can potentially be at least an order of magnitude more sensitive than Ninhydrin. Cyanoacrylate ester fumes preferentially build up and polymerize on the residual fingerprint deposits, these polymers can be visualized and photographed.

As a result, there is a hierarchy of methods of increasing sophistication, ranging from visual examination at one end, to forensic light examination, DFO chemistry, ninhydrin chemistry, ninhydrin plus physical developer chemistry, and so on.

Once the latent fingerprint of a legitimate user has been obtained, it can then be used to photographically etch a replica fingerprint using a photochemical process or computer machining process, and this in turn can be used to create a fingerprint replica out of a natural looking material, such as gelatin. This is often called the “Gummy Bear attack”, because the first example of this attack used the same candy grade gelatin used for the popular “Gummy Bear” candy. This replica fingerprint can then be used to attempt to spoof a fingerprint sensor for a secure device or area. (See Tsutomu Matsumoto, et. al., Impact of Artificial “Gummy” Fingers on Fingerprint Systems, Prepared for Proceedings of SPIE vol. #4677, Optical Security and Counterfeit Deterrence Techniques IV January 2002).

### BRIEF SUMMARY OF THE INVENTION

The invention is an enhanced security fingerprint scanner method and system designed to minimize the risk of fingerprint “spoofing” by minimizing the probability that latent fingerprints from authorized users will be inadvertently left on the device in a detectable form. In a preferred embodiment, surfaces of the device where the probably of authorized users inadvertently leaving latent fingerprints is particularly high are covered with fingerprint resistant or camouflaging material.

### BRIEF DESCRIPTION OF THE DRAWINGS

FIG. 1 shows a natural fingerprint resistant surface.

FIG. 2 shows a surface treated to camouflage fingerprints

FIG. 3 shows a composite material surface designed to both resist fingerprints and camouflage fingerprints.

FIG. 4A shows a fingerprint sensor equipped smart card covered with fingerprint resistant surfaces.

FIG. 4B shows a fingerprint sensor equipped smart key fob equipped with fingerprint resistant surfaces.

FIG. 4C shows a fingerprint sensor equipped cell phone equipped with fingerprint resistant surfaces.

FIG. 4D shows a fingerprint sensor equipped laptop computer equipped with fingerprint resistant surfaces.

### DETAILED DESCRIPTION

Over the past hundred years, there has been much forensic science effort devoted to learning how to recover latent fingerprints from problematic surfaces. Using these techniques, fingerprints can be retrieved from such difficult materials as paper, cardboard, and even human skin. In order to optimize the design of fingerprint resistant surfaces, this forensic teaching must be studied and then circumvented.

In general, forensic science teaches that very rough or very textured surfaces tend to be more fingerprint resistant. Natural surfaces that are known to be fingerprint resistant include very rough leather, and coarse weave cloth. Thus in one simple embodiment of the invention, many of the surfaces of a fingerprint sensor equipped devices can be covered with such fingerprint resistant natural materials.

One problem, however, is that such natural materials have problematic properties (e.g. ugly appearance, lack of moisture resistance, etc), and additionally these materials would be conspicuous and out of place in most fingerprint sensor equipped devices. As an example, a rough leather, felt, or burlap (coarse cloth) covered laptop computer might indeed be relatively fingerprint resistant over much of its surface, but this will visually distinguish the device from similar devices that are carrying non-sensitive information. Since one major protection means is anonymity, that is, a device carrying sensitive information should preferably be visually inconspicuous, i.e. look similar to a device carrying non-sensitive information, use of natural materials may, in some circumstances, impair security because they draw attention to the secure device.

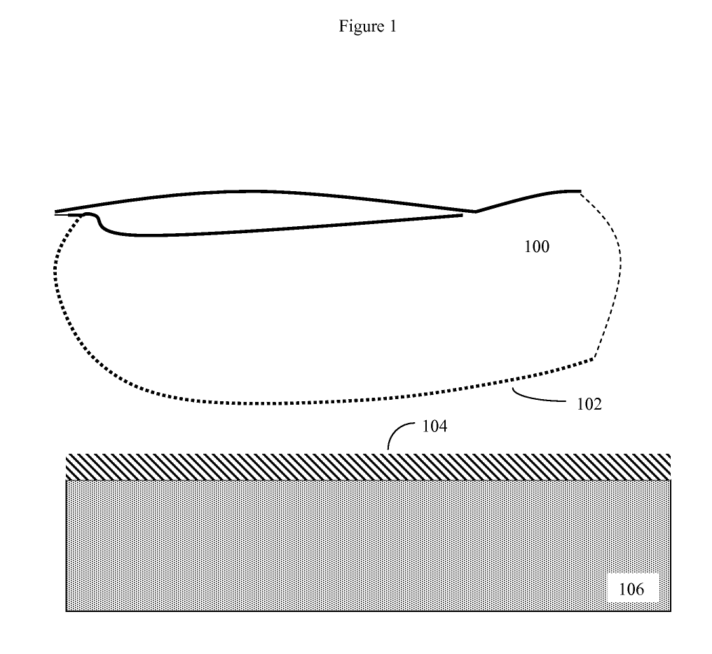

FIG. 1 shows an example of a fingerprint resistant surface made from natural materials. Here a finger (100), with a fingerprint surface (102), is unable to make a full fingerprint on the rough surface (104) of a natural material covering a secure electronic device (106).

At present, the convention for minimal security laptops, cell phones, smart cards and other devices is to make these devices out of metal or plastic. In many situations it will thus be desirable to employ a fingerprint resistant surface that mimics the visual appearance of the standard non-fingerprint resistant surfaces commonly used for consumer electronics.

Although prior art methods have discussed using fingerprint resistant coatings for electronic devices, the intent has always been to simply keep the devices clean looking. Use of fingerprint resistant coating and surface materials as a method to block fingerprint spoofing method has not been contemplated. Thus one aspect of the invention is a method to improve the security of fingerprint sensor equipped electronic devices, in which the ability of an attacker to spoof the fingerprint sensor by obtaining a fingerprint of an authorized user, and then using this fingerprint to spoof the fingerprint sensor, is diminished by using fingerprint resistant materials to form the surfaces of the device. Preferably these fingerprint resistant materials should be chosen, selected, or engineered to be resistant to latent fingerprints, or to be resistant to common forensic methods used to detect and image latent fingerprints.

A variety of techniques may be used to produce a forensic-grade fingerprint resistant surface. One simple method is to texture the surface using textures with sufficient relief that the not the entire fingerprint is captured by the surface. For example, if the surface has raised and lowered areas that vary with sufficient distance, such as an approximately one millimeter distance, then the portions of the finger that the top of the textures will be unlikely to contact the bottom of the texture, and thus only a portion of the fingerprint will be captured by the surface. Although this type of surface has the drawback of being somewhat visually conspicuous, the visual contrast can be minimized by making the surface a uniform color, such as a mat finish black or white, which will minimize the visual impact of the texture.

A variety of non-stick surfaces are known to be at least somewhat fingerprint resistant. For example, non-stick polymers such as polytetrafluoroethylene polymers, perfluoroalkoxy, and fluorinated ethylene propylene polymers (often referred to by the DuPont trademark name of “Teflon®”) polymers may be used. Other non-stick surfaces are aliphatic and aromatic polyisocyanate (described in U.S. Pat. No. 4,758,622). US application 20060110537 teaches use of hydrophobic nanocomposite materials, oleophobic nano-composite materials, and super-amphiphobic nano-composite materials, and US application 20030209293 teaches treating a metal surface with vanadium compounds, and overcoating the surface with various organic compounds. Such non-stick surfaces may be used for the present invention, and their use may optionally be further facilitated by suitable texturing as to make it unlikely that a complete fingerprint will be captured on the surface.

In spite of careful selection of fingerprint resistant materials, however, latent fingerprints may still persist, even on fingerprint resistant surfaces, and these latent fingerprints may be revealed to an attacker making use of latent fingerprint developing reagents and kits. Since many of these kits are commercially available, these reagents are and kits are easy to obtain. Thus in certain situations, it will be useful to enhance the latent fingerprint resistant properties of the surface by embedding one or more materials into the surface that are designed to defeat commonly used latent fingerprint developing methods.

Many of the chemical detection methods rely on fluorescence or luminescence, and thus backgrounds that expose a hidden camouflage pattern when illuminated with a high degree of luminescence or fluorescence are useful. These can interfere with luminescent or fluorescent fingerprint detection techniques. One advantage of this approach is that fluorescent or luminescent dyes or lakes may be printed or embedded on or near the surface of a fingerprint resistant surface or coating so as to produce a confusing pattern when the surface is illuminated with fluorescent light or bandpass limited light, and light emitting from this surface is then emitted at a different wavelength. For example, a surface printed with many different fluorescent random fingerprint patterns would tend to look inconspicuous when viewed with normal illumination, yet reveal a confusing pattern when viewed with forensic lighting techniques. This confusing pattern would help obscure the pattern produced by a latent fingerprint from an authorized user. One additional advantage of this approach is that such patterns could be protected by a transparent fingerprint resistant coating, and thus would be resistant to wiping or other types of damage.

Other chemical detection methods rely on chemical reagents that react with the protein components of a fingerprint, such as trace amounts of urea or amino acids. Here, a fingerprint resistant surface might also be printed or embedded with amino group containing chemicals, or polymers, many of which are also nearly invisible. These patterns might also be designed to look like various random fingerprints, and might again confound certain types of forensic reagents.

Fingerprints often deposit small amounts of salts and amino acids, which are hydrophilic, and small amounts of lipids, which are hydrophobic, on surfaces. This produces a series of hydrophilic and hydrophobic patterns which can be visualized by powders and other reagents. Here again, printing a surface with various patterns may be useful to defeat fingerprint detection methods in certain situations.

One common method to detect latent fingerprints is to expose surfaces to cyanoacrylate (super glue) fumes. The cyanoacrylate molecules build up on latent fingerprint images, and the resulting patterns can then be visualized either directly or with the aid of additional chemical developers to further enhance the image. Here, printing a surface with various polycyanoacrylate patterns may be useful to defeat the cyanoacrylate (super glue) fume latent fingerprint detection methods in certain situations.

An additional advantage of cyanoacrylate printing is that it is a liquid which, when hardened, adheres tenaciously to surfaces, and thus will be resistant to washing. In some embodiments, liquid cyanoacrylate or other material known to be receptive to cyanoacrylate vapors may be spiked or loaded with fluorescent chemicals, such as rhodamine, and or amino groups designed to confound a ninhydrin or other type latent image detection spray. This could then be printed, sprayed or otherwise applied to the normal (non-fingerprint adherent) surfaces of commercially available fingerprint sensor equipped devices, such as commercial laptop computers, cell phones, smart cards, USB memory sticks, and the like. These devices could thus be rendered fingerprint resistant by the original manufacturer, or alternatively could be rendered fingerprint resistant as a retrofit or after market application.

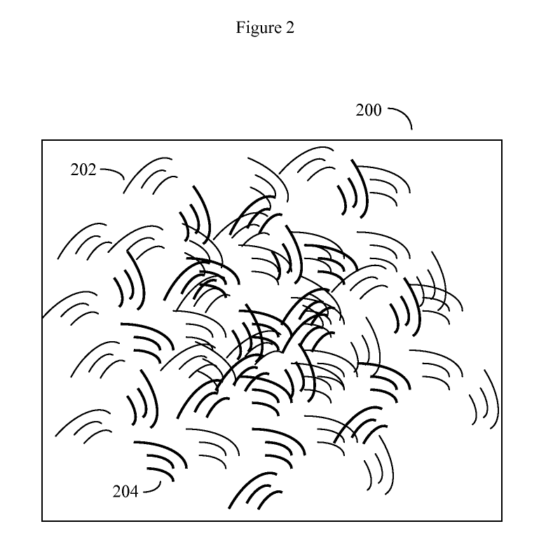

FIG. 2 shows an example of a surface (200) that has been treated with latent fingerprint camouflaging agents. In this example, these agents might be a mix of random fluorescent or luminescent partial fingerprint patterns (202), and a mix of random polycyanoacrylate material (204) spiked with other chemicals, such as amino groups, needed to confuse latent fingerprint developing chemicals. These may be printed in various confusing patterns, such as ridges with typical fingerprint spacing, in order to make visual detection of the user's latent fingerprint as difficult as possible. Although these patterns are shown as visible in FIG. 2, in a preferred embodiment, these patterns and chemicals may be invisible to the naked eye so as to avoid drawing attention to the fingerprint resistant unit. This type of treatment may be suitable for transparent display surfaces, as well as non-transparent surfaces.

Often it may be desirable to use multiple latent fingerprint defeating methodologies at the same time. Thus a surface might be composed of a fingerprint resistant material, contain some texture intended to render certain portions of a fingerprint inaccessible, and may also contain one or more methods, such as an invisible printed fingerprint pattern, designed to confound forensic light, luminescent, or fluorescent latent image detection methods.

In general, when display surfaces which might be touched by a legitimate user, such as liquid crystal displays (LCD) displays, electronic paper, or other commonly used displays, the use of thin transparent fingerprint resistant coatings, supplemented by invisible printed fluorescent, luminescent, or other chemical pattern designed to confound chemical analysis, is desirable. This type of technique makes it difficult to detect latent fingerprints, yet is inconspicuous. Alternatively, the display screen may be covered by a thin transparent mesh, such as a polymer woven or non-woven fabric, with a coarse enough mesh to not itself hold fingerprints, substantial enough to keep an authorized user's finger from accidentally touching the display.

For non-display surfaces, as an alternative technique, a composite material might be devised by embedding many fine granules of various small particles designed to confound various fingerprint sensing techniques into a carrier matrix, such as a fingerprint resistant fluorocarbon polymer, or other matrix. As an example, a sintered Teflon-melamine-fluorescent plastic, polycyanoacrylate composite, composed of roughly 0.1 to 1 mm sized granules would be an extremely difficult synthetic material to obtain latent fingerprint images from. The surface would be rough, the rough Teflon polymer would resist fingerprints, the melamine or other amino group containing plastic granules would throw off a ninhydrin analysis, the fluorescent granules would throw off a fluorescent developing agent, and the polycryanoacrylate granules would throw off a cyanoacrylate reagent.

Various methods of producing such composite materials are known in the art. For example, one such technique, which may be suitable for certain applications, is taught by U.S. Pat. No. 4,580,790, which teaches a sintered polytetrafluoroethylene composite material composed of polytetrafluoroethylene and 5 to 50 percent volume of various types of particles.

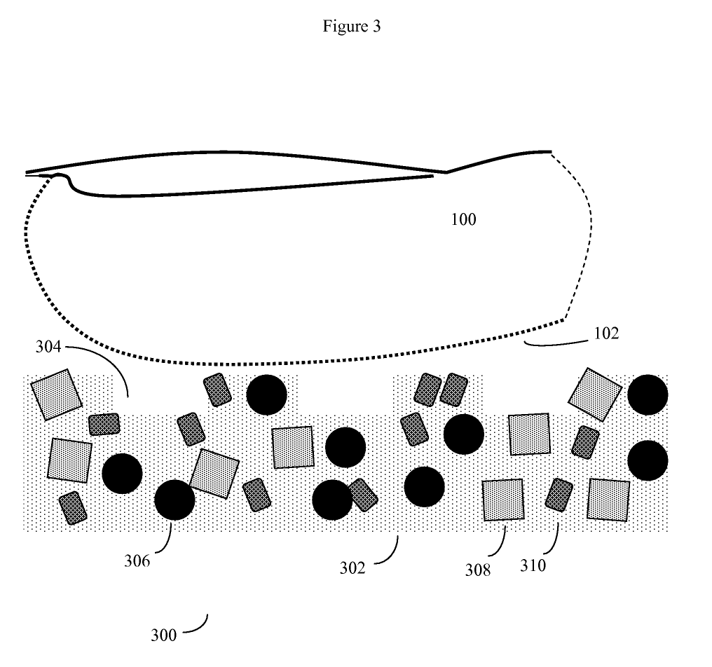

FIG. 3 shows an example of a fingerprint resistant surface made from a composite material (300). The material matrix itself (302) may be a fingerprint resistant material such as a fluorocarbon polymer. This material may also be machined or molded into ridges (304) of sufficient depth that a fingerprint will only make an impression on the tops of the ridges and not the bottom of the ridges. This material matrix may contain granules of a fluorescent material (306), an amino group containing material (308) and a polycyanoacrylate material (310) or other materials as needed to throw off various latent fingerprint analyzing chemicals. Other materials may include magnetic particles, hydrophobic particles, and hydrophilic particles. Ideally the carrier matrix and the various granules should be made a uniform or pleasing color (such as black) and the optional groves or ridges (304) should be done with a typical industrial design pattern, in order to make this surface appear inconspicuous.

Regardless of the fingerprint resistance technique used, an attacker coming into possession or control of a fingerprint resistant device equipped with a fingerprint sensor will find that attacking the sensor is now more difficult. Even if the fingerprint resistance is not absolute, simply the ability to withstand quick or casual attacks will convey a significantly higher degree of security.

As an example, laptop computers, cell phones, and other devices are often accidentally or deliberately left in unsecure locations, such as conference rooms, for brief periods of time. During this time, these devices are potentially subject to attack. If the device does not have fingerprint resistant materials, common equipment, such as powder and a cell phone camera, may be sufficient to deduce the authorized users fingerprint.

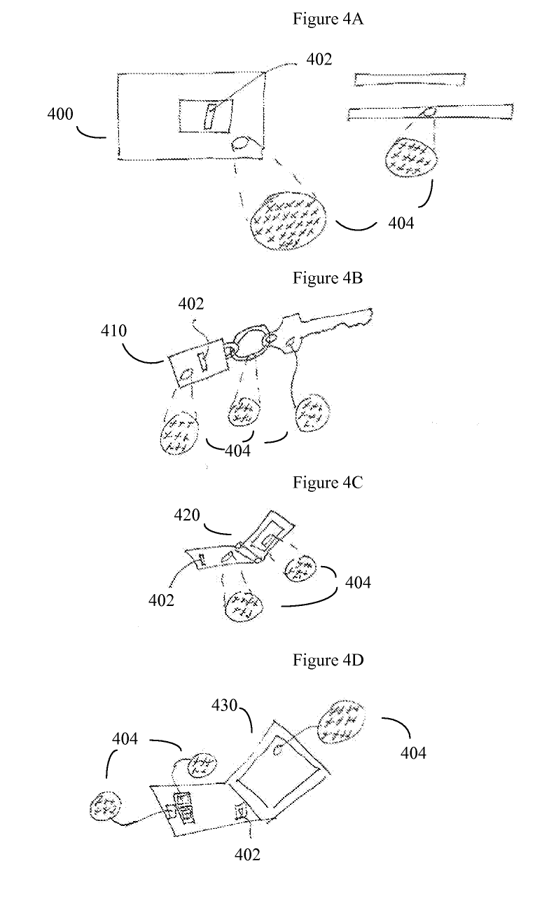

FIG. 4A shows a smart card (400) equipped with a fingerprint scanner (402) and fingerprint resistant surfaces (404).

FIG. 4B shows a memory dongle (410), such as a USB memory dongle keychain, equipped with a fingerprint scanner (402) and fingerprint resistant surfaces (404).

FIG. 4C shows a cell phone (420) equipped with a fingerprint scanner (402) and fingerprint resistant surfaces (404).

FIG. 4D shows a laptop computer (430) equipped with a fingerprint scanner (402) and fingerprint resistant surfaces (404).

By making a potential attacker shift to more complex and time consuming methods of latent fingerprint detection, the job of the attacker becomes much harder. By making a potential attacker run through multiple latent fingerprint detection methods, the job of the attacker becomes still harder and more time consuming. Every minute extra that an attacker spends trying to detect an authorized user's fingerprint is an extra minute that the legitimate user has to detect the loss of the device, and or change passwords or notify security personnel. Thus fingerprint detection resistant surfaces should ideally be a component of any fingerprint sensing electronic device.

1. A fingerprint sensor system, comprising:
a sensor configured to sense a fingerprint when juxtaposed proximally thereto;
a sensor surface onto which a user can swipe a fingerprint to be sensed; and
a fingerprint-resistant surface covering an area of the device to prevent a user from leaving a discernable fingerprint impression on the device.

2. A system according to claim 1, wherein the fingerprint sensor system is configured in a device that a user contacts while swiping a fingerprint to authenticate the user of the device.

3. The system of claim 1, in which the fingerprint-resistant surface is selected from the group consisting of rough leather or cloth.

4. The system of claim 1, in which the fingerprint-resistant surface is selected from the group consisting of fluorocarbon materials, polytetrafluoroethylene polymers, perfluoroalkoxy polymers, fluorinated ethylene propylene, aliphatic and aromatic polyisocyanate, hydrophobic nanocomposite materials, and vanadium treated metal surfaces.

5. The system of claim 1, in which the fingerprint-resistant surface is composed of a composite material containing one or more granules selected from the group consisting of fluorocarbon, melamine, fluorescent plastic, amino-group containing materials, cryanoacrylate materials, metallic materials, and metal materials.

6. The system of claim 1 where specific surface patterns are etched or formed on to a contacted surface designed to provide maximum interference with said discernable fingerprint impressions left on the device.

7. The system of claim 5, in which the average diameter of at least one of the granular materials is between 0.1 and 2 mm.

8. The system of claim 5, in which the fingerprint-resistant surface has a rough or mat finish.

9. The system of claim 1, wherein said system has a visual display, and wherein said visual display is also is covered with a fingerprint resistant surface.

10. The system of claim 9, wherein said visual display has a fluorocarbon coating.

11. The system of claim 9, wherein said visual display has a woven or non-woven mesh covering.

12. The system of claim 1, wherein said system is selected from the group consisting of smart cards, personal digital assistants, laptop computers, and USB dongles.

13. The system of claim 1, wherein said sensor is a partial fingerprint sensor.

14. The system of claim 13, wherein said sensor is a deep finger penetrating radio frequency (RF) based partial fingerprint sensor.

15. A method of enhancing the security of a fingerprint sensor equipped electronic device, said method comprising forming at least some of the surfaces of said device from fingerprint resistant materials.

16. The method of claim 15, in which at least some of the fingerprint resistant materials are selected so as to visually resemble non-fingerprint resistant materials.

17. The method of claim 15, in which at least some of the fingerprint resistant materials are formed by coating a material with a fingerprint resistant coating.

18. The method of claim 15, in which the fingerprint resistant materials are selected from the group consisting of rough leather or cloth.

19. The method of claim 15, wherein the fingerprint sensor is a partial fingerprint sensor.

20. The method of claim 19, wherein the partial fingerprint sensor is a deep finger penetrating radio frequency (RF) based partial fingerprint sensor.

21. The method of claim 15, in which the fingerprint resistant materials are chosen, selected, or engineered to be resistant to latent fingerprints, or to be resistant to common forensic methods used to detect and image latent fingerprints.

22. A method of enhancing the security of a fingerprint sensor equipped electronic device, said method comprising printing or applying a fingerprint camouflage over at least some of the surfaces of said device.

23. The method of claim 22, in which a fluorescent pattern designed to obscure latent fingerprint ridges detected by a fluorescent or luminescent latent fingerprint developing reagent is applied to the surface.

24. The method of claim 22, in which a pattern designed to obscure fingerprint ridges detected by an amino or protein detecting latent fingerprint developing reagent is applied to the surface.

25. The method of claim 22, in which a pattern designed to obscure fingerprint ridges detected by a cyanoacrylate based latent fingerprint developing reagent is applied to the surface.

26. The method of claim 22, in which a pattern designed to obscure hydrophilic binding, hydrophobic binding, or magnetic dust based developing reagents is applied to the surface.
